(19) United States
(12) Patent Application Publication
(10) Pub. No.: US 2016/0335249 A1
(43) Pub. Date: Nov. 17, 2016

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Ryuji KANO, Kanagawa (JP)

(73) Assignee: FUJI XEROX CO., LTD., Tokyo (JP)

(21) Appl. No.: 14/919,927

(22) Filed: Oct. 22, 2015

(30) Foreign Application Priority Data
May 14, 2015 (JP) 2015-099128

(51) Int. Cl. G06F 17/27

(52) U.S. Cl. CPC G06F 17/2755; G06F 17/2775

(57) ABSTRACT

An information processing apparatus includes a forming unit and an extracting unit. The forming unit forms, from a co-occurrence network representing a correlation among plural morphemes included in plural sentences, plural clusters each including plural morphemes related to one another. The extracting unit extracts, from each of the plural clusters formed by the forming unit, one or more subgraphs each including plural morphemes that satisfy a predetermined condition representing a mutual correlation.

### CROSS-REFERENCE TO RELATED APPLICATIONS

This application is based on and claims priority under 35 USC 119 from Japanese Patent Application No. 2015-099128 filed May 14, 2015.

### BACKGROUND

### Technical Field

The present invention relates to an information processing apparatus, an information processing method, and a non-transitory computer readable medium.

### SUMMARY

According to an aspect of the invention, there is provided an information processing apparatus including a forming unit and an extracting unit. The forming unit forms, from a co-occurrence network representing a correlation among plural morphemes included in plural sentences, plural clusters each including plural morphemes related to one another. The extracting unit extracts, from each of the plural clusters formed by the forming unit, one or more subgraphs each including plural morphemes that satisfy a predetermined condition representing a mutual correlation.

### BRIEF DESCRIPTION OF THE DRAWINGS

An exemplary embodiment of the present invention will be described in detail based on the following figures, wherein:

FIG. 1 is a block diagram illustrating an electric configuration of an information processing apparatus according to the exemplary embodiment;

FIG. 2 is a block diagram illustrating a functional configuration of the information processing apparatus according to the exemplary embodiment;

FIG. 3 is a schematic diagram illustrating an example of plural sentences according to the exemplary embodiment;

FIG. 4 is a schematic diagram illustrating an example of a co-occurrence network according to the exemplary embodiment;

FIG. 5 is a schematic diagram illustrating an example of clusters formed from the co-occurrence network according to the exemplary embodiment;

FIG. 6 is a schematic diagram illustrating an example of subgraphs extracted from a cluster according to the exemplary embodiment;

FIG. 7 is a schematic diagram illustrating an example of information on a hierarchical structure according to the exemplary embodiment;

FIG. 8 is a flowchart illustrating a processing flow of a program of totalization processing according to the exemplary embodiment; and

FIG. 9 is a flowchart illustrating a flow of routine processing of a program of subgraph extraction processing according to the exemplary embodiment.

### DETAILED DESCRIPTION

Hereinafter, an information processing apparatus according to an exemplary embodiment will be described with reference to the attached drawings.

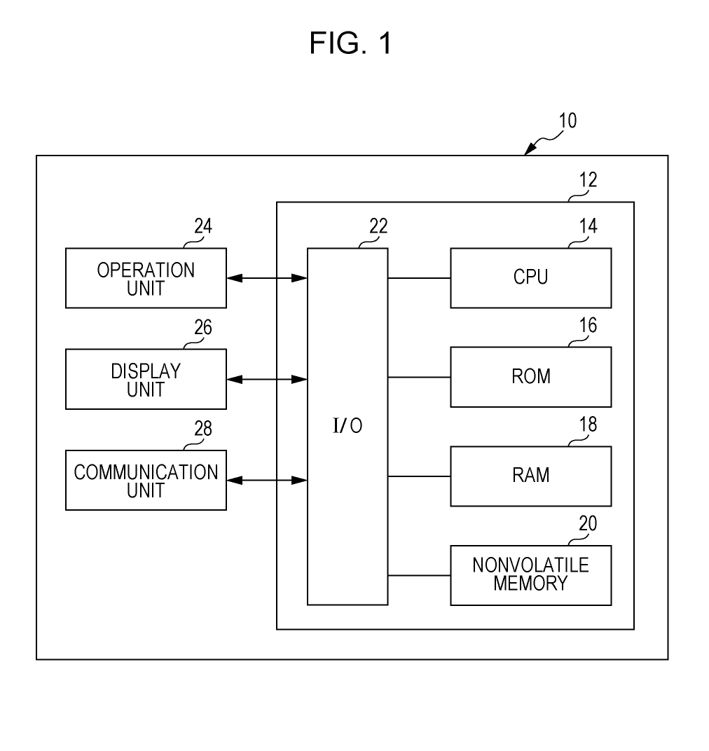

As illustrated in FIG. 1, an information processing apparatus 10 according to the exemplary embodiment includes a controller 12 that controls the overall apparatus. The controller 12 includes a central processing unit (CPU) 14, a read only memory (ROM) 16, a random access memory (RAM) 18, a nonvolatile memory 20, and an input/output (I/O) interface 22. The CPU 14 executes various processing operations including totalization processing and subgraph extraction which will be described below. The ROM 16 stores programs and various pieces of information that are used for the processing operations executed by the CPU 14. The RAM 18 functions as a working area of the CPU 14 and temporarily stores various pieces of data. The nonvolatile memory 20 stores various pieces of information that are used for processing operations executed by the CPU 14. The I/O interface 22 is used for input of data from and output of data to an external apparatus connected to the information processing apparatus 10. The I/O interface 22 is connected to an operation unit 24 that is operated by a user, a display unit 26 that displays various pieces of information, and a communication unit 28 that communicates with an external apparatus.

The nonvolatile memory 20 stores sentence information representing a sentence group including plural sentences created by plural users. The sentence information is received from client terminals respectively held by the individual users and stored in the nonvolatile memory 20. Each of the plural sentences includes an issue. In the exemplary embodiment, issues included in the individual sentences are analyzed to determine which kind of issues and how many issues are included in the sentence group in the manner described below.

First, the information processing apparatus 10 according to the exemplary embodiment creates a co-occurrence network representing a correlation among plural morphemes included in the sentence group and forms, from the created co-occurrence network, plural clusters each including plural morphemes that are related to one another. The cluster represents an outline of an issue that is expected to be included in each of plural sentences.

The information processing apparatus 10 according to the exemplary embodiment extracts, from each of the plural clusters that have been formed, one or more subgraphs each including plural morphemes that satisfy a predetermined condition (a third condition described below) representing mutual correlation. The subgraph represents a specific issue that is expected to be included in each of plural sentences.

Further, the information processing apparatus 10 according to the exemplary embodiment associates morphemes included in the extracted subgraph with morphemes included in the sentence group, and totals the number of sentences corresponding to the subgraph by using attribute values of the morphemes included in the subgraph.

In this way, the information processing apparatus 10 according to the exemplary embodiment performs clustering on the plural morphemes included the sentence group in two stages, that is, the stage of a cluster representing an outline of an issue and the stage of a subgraph representing a specific issue. Accordingly, a more specific issue that is expected to be included in each of plural sentences is extracted from the sentence group. Also, the information processing apparatus 10 according to the exemplary embodiment totals the number of sentences corresponding to the subgraph representing the specific issue. Accordingly, the information processing apparatus 10 according to the exemplary embodiment totals the amount of more specific issues included in the sentence group.

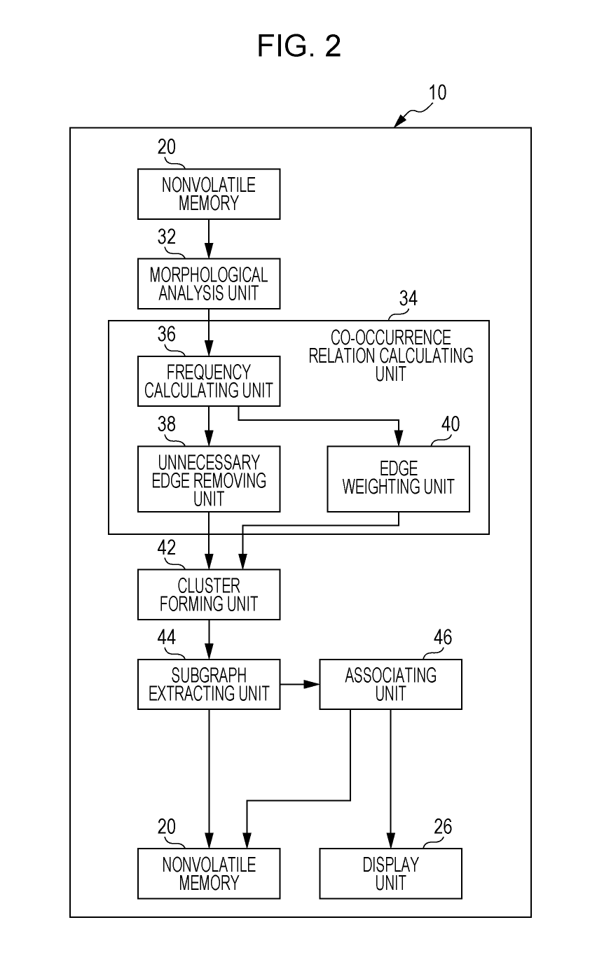

For this purpose, the information processing apparatus 10 according to the exemplary embodiment includes, as illustrated in FIG. 2, a morphological analysis unit 32, a co-occurrence relation calculating unit 34, a cluster forming unit 42, a subgraph extracting unit 44, and an associating unit 46. The co-occurrence relation calculating unit 34 includes a frequency calculating unit 36, an unnecessary edge removing unit 38, and an edge weighting unit 40. These units are implemented under the control performed by the CPU 14.

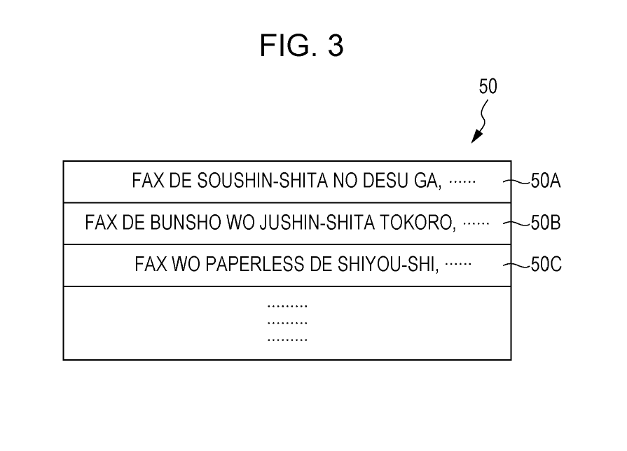

The morphological analysis unit 32 obtains the above-described sentence information and divides each of plural sentences included in a sentence group represented by the obtained sentence information into morphemes. For example, as illustrated in FIG. 3, a sentence group 50 includes a sentence 50A “FAX de soushin-shita no desu ga, . . . ” (I sent it by FAX, but), a sentence 50B “FAX de bunsho wo jushin-shita tokoro, . . . ” (when I received a document by fax), and a sentence 50C “FAX wo paperless de shiyou-shi, . . . ” (I use the fax in a paperless manner, and). In a case where the morphological analysis unit 32 obtains the sentence 50A “FAX de soushin-shita no desu ga, . . . ”, the morphological analysis unit 32 divides the sentence 50A into plural morphemes: a noun “FAX”, a postpositional particle “de”, a verb “soushin-shita”, a postpositional particle “no”, an auxiliary verb “desu”, and a conjunction “ga”.

In the exemplary embodiment, morphological analysis is performed by using a MeCab method according to the related art. Alternatively, another method according to the related art, such as JUMAN, Kuromoji, or Chasen, may be used.

Also, the morphological analysis unit 32 extracts morphemes of specific parts of speech from among the morphemes obtained through division. In the exemplary embodiment, the specific parts of speech are noun, adjective, and verb. For example, as illustrated in FIG. 3, the morphological analysis unit 32 extracts, from the sentence 50A “FAX de soushin-shita no desu ga, . . . ”, a noun “FAX” and a verb “soushin” (stem). In the exemplary embodiment, noun, adjective, and verb are extracted from among morphemes obtained through division, but the parts of speech to be extracted are not limited to those described above. For example, one or two of noun, adjective, and verb may be extracted, or another part of speech may be extracted.

The frequency calculating unit 36 calculates, as a term frequency, the number of times two morphemes as targets of calculation simultaneously appear in a predetermined region of a sentence group. The method for calculating a term frequency is not limited thereto. For example, a value obtained by dividing the number of times two morphemes as targets of calculation simultaneously appear in a predetermined region in plural sentences by the number of times all combinations of two morphemes are included in the plural sentences may be calculated as a term frequency. The term frequency represents the intensity of co-occurrence of two morphemes. In the exemplary embodiment, the predetermined region is either of the following (a) and (b).

(a) A region of at least part of a sentence group (Note that one sentence is one unit.)

(b) A region within a predetermined distance (for example, a distance corresponding to up to ten interposed words) in a sentence group

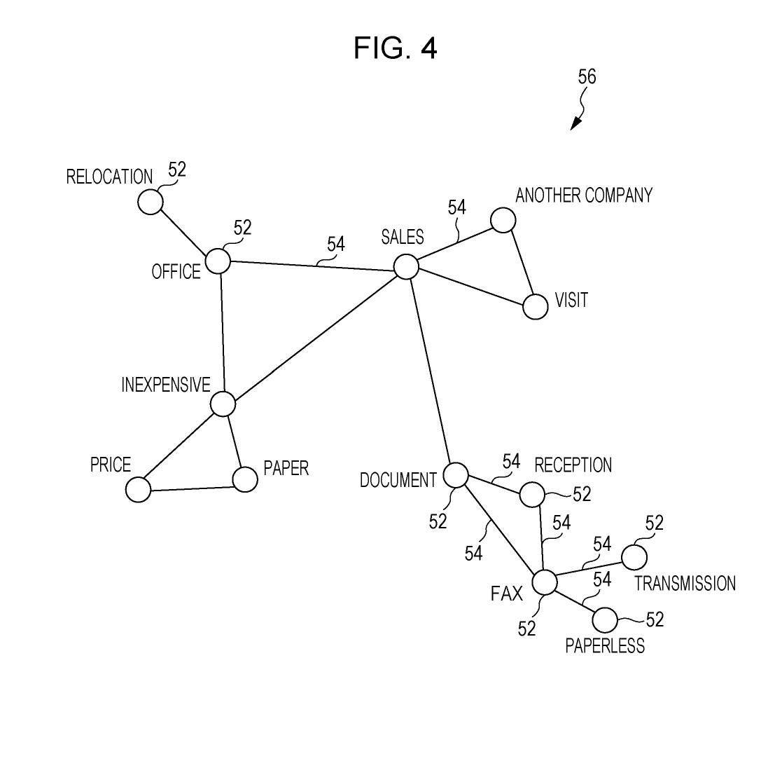

As illustrated in FIG. 4, the co-occurrence relation calculating unit 34 regards extracted morphemes as nodes 52 and connect morphemes having a co-occurrence relation to one another by edges 54 to create a co-occurrence network 56 on the basis of the co-occurrence relation among the individual morphemes. In a case where a term frequency calculated for two morphemes is equal to or higher than a threshold that is predetermined as a value representing correlation, it is determined that these morphemes have a co-occurrence relation.

In the example illustrated in FIG. 4, the node 52 “FAX” and the node 52 “transmission” are connected to each other by the edge 54, and the node 52 “FAX” and the node 52 “reception” are connected to each other by the edge 54. A method according to the related art is applicable as a method for creating the co-occurrence network 56. For example, KH Coder or methods described in Japanese Unexamined Patent Application Publication No. 2009-93655, Japanese Unexamined Patent Application Publication No. 2002-183175, and WO 06/048998 may be used.

In a case where two morphemes connected to each other in the co-occurrence network created by the co-occurrence relation calculating unit 34 satisfy a predetermined first condition, the unnecessary edge removing unit 38 removes the edge of these morphemes. In the exemplary embodiment, the first condition is at least one of the following (c) and (d).

(c) A case where a Jaccard coefficient representing set similarity, a Simpson's coefficient representing the intensity of frequency at which plural words appear in the same sentence, a Cosine distance representing set similarity, or a mutual information amount representing a degree of interdependence of two random variables is within a range that is predetermined as a range of no correlation

(d) A case where the parts of speech of plural morphemes connected to one another are the same

A method according to the related art is used as a method for removing an edge, for example, the method described in Japanese Unexamined Patent Application Publication No. 2009-140263 is used.

In the exemplary embodiment, the condition (d) defines a case where the parts of speech of plural morphemes are the same. Alternatively, a case where the parts of speech of plural morphemes are specified (for example, verb) may be defined as the condition (d).

In the exemplary embodiment, in a case where two morphemes connected to each other satisfy the above-described first condition, the edge of these morphemes is removed. Alternatively, the intensity of co-occurrence of these morphemes may be reduced. In this case, the term frequency calculated by the frequency calculating unit 36 may be reduced to half, for example, so as to reduce the intensity of the edge of the plural morphemes.

In a case where plural morphemes connected to one another in the co-occurrence network created by the co-occurrence relation calculating unit 34 satisfy a predetermined second condition, the edge weighing unit 40 increases the intensity of the edge of these morphemes, that is, the intensity of co-occurrence. In the exemplary embodiment, the term frequency calculated by the frequency calculating unit 36 is doubled so as to increase the intensity of the edge of the plural morphemes. In the exemplary embodiment, the second condition is at least one of the following (e) and (f).

(e) A case where a Jaccard coefficient representing set similarity, a Simpson's coefficient representing the intensity of frequency at which plural words appear in the same sentence, a Cosine distance representing set similarity, or a mutual information amount representing a degree of interdependence of two random variables is within a range that is predetermined as a range of no correlation

(f) A case where the parts of speech of plural morphemes connected to one another are different

In the exemplary embodiment, the condition (f) defines a case where the parts of speech of plural morphemes are different. Alternatively, in a case where the parts of speech of plural morphemes are specific parts of speech (for example, noun and verb), the intensity of the edge of these morphemes may be increased.

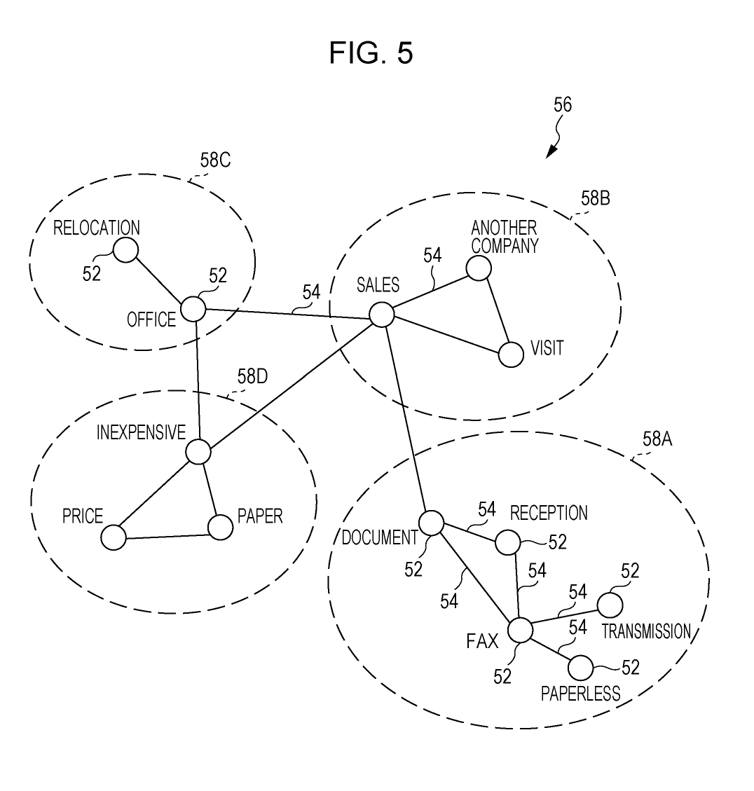

As illustrated in FIG. 5, the cluster forming unit 42 classifies the morphemes included in the co-occurrence network 56 into plural clusters 58A to 58D (hereinafter also referred to as clusters 58), each including plural morphemes related to one another, on the basis of the calculated term frequency. In this way, the cluster forming unit 42 forms the plural clusters 58. In the example illustrated in FIG. 5, the cluster 58A including five nodes 52, that is, the node 52 “FAX”, the node 52 “document”, the node 52 “reception”, the node 52 “transmission”, and the node 52 “paperless”, and so forth are formed.

In the exemplary embodiment, clustering is performed by using a Modularity method, which is a method according to the related art for forming the plural clusters 58 without causing overlap of individual morphemes with other clusters. Accordingly, the time for performing clustering is shortened. Methods according to the related art are applicable as a clustering method, for example, Hamiltonian, Girvan-Newman, Clique percolation, Random walk, or the like may be used.

The subgraph extracting unit 44 extracts, from each of the plural clusters that have been formed, one or more subgraphs each including plural morphemes that satisfy the predetermined third condition representing mutual correlation. In the exemplary embodiment, the third condition is at least one of the following (g) to (i). Accordingly, the individual morphemes are classified into plural subgraphs while being overlapped with other clusters. Also, a more specific issue is extracted accordingly.

(g) Plural morphemes all of which are connected to one another in a co-occurrence network

(h) Plural morphemes in which an average value or a minimum value of weights of edges between the plural morphemes connected to one another is equal to or larger than a first threshold that is predetermined as a value representing correlation

(i) Plural morphemes in which an average value or a minimum value of orders of nodes of the plural morphemes connected to one another is equal to or larger than a second threshold that is predetermined as a value representing correlation

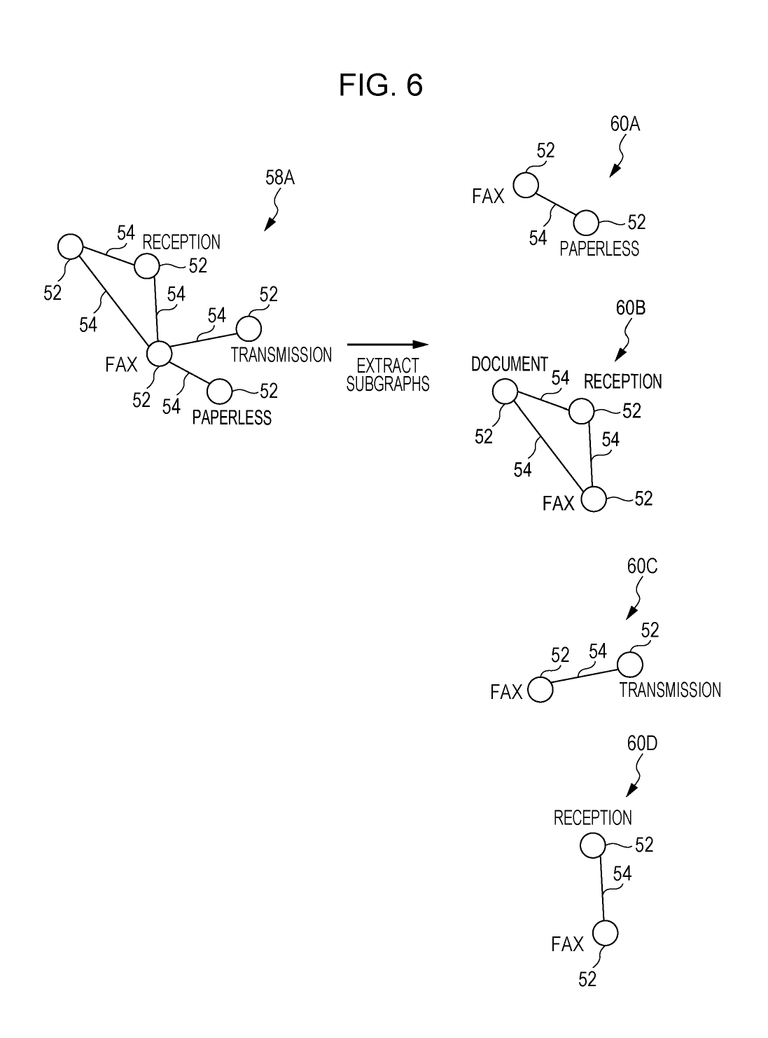

In the example illustrated in FIG. 6, a subgraph 60A including the node 52 “FAX” and the node 52 “paperless”; a subgraph 60B including the node 52 “FAX”, the node 52 “document”, and the node 52 “reception”; a subgraph 60C including the node 52 “FAX” and the node 52 “transmission”; and a subgraph 60D including the node 52 “FAX” and the node 52 “reception” are extracted from the cluster 58A.

The subgraph extracting unit 44 creates information on a hierarchical structure in which clusters are in an upper layer and subgraphs included in each of the clusters are in a lower layer, and stores the information in the nonvolatile memory 20. At this time, the subgraph extracting unit 44 uses, as a cluster name, a morpheme that is included in a cluster and that satisfies a predetermined fourth condition. In the exemplary embodiment, the fourth condition is the following (j).

(j) A morpheme whose index value indicating a degree of importance of the morpheme is maximum

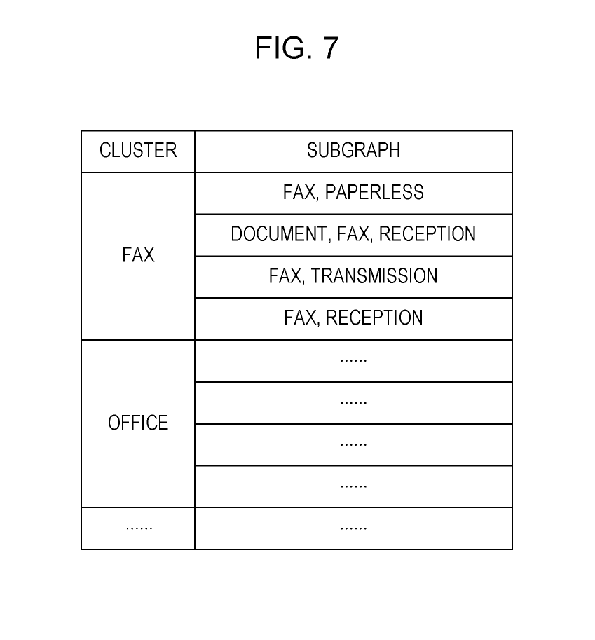

For example, as illustrated in FIG. 7, in information on a hierarchical structure, the plural subgraphs 60A to 60D are associated in a lower layer of the cluster 58A having a cluster name “FAX”. Accordingly, it becomes recognizable that the cluster 58A includes an issue regarding “FAX”. Also, the number of corresponding sentences is totaled for each cluster representing an outline of an issue and each subgraph representing a more specific issue.

In the exemplary embodiment, a description has been given of a case where one morpheme whose physical amount representing a degree of importance of the morpheme is maximum is used as a cluster name in the above-described (j). Alternatively, a combination of plural morphemes whose physical amount representing a degree of importance of the morphemes is maximum may be used as a cluster name.

In the exemplary embodiment, a tf-idf value expressed by the following equation (1) is used as an index value indicating a degree of importance of a morpheme. In equation (1), f j represents the number of appearances of a morpheme wⱼ in plural sentences, m represents the total number of sentences, and mⱼ represents the number of sentences including the morpheme wⱼ. The tf-idf value is a product of tf representing a term frequency of a morpheme and idf representing an inverse document frequency. As the tf-idf value increases, the degree of importance of the morpheme increases. As the tf-idf value decreases, the degree of importance of the morpheme decreases.

$$tf - idf ( {w}_{j} , d ) = \frac{{f}_{j} \times log ( \frac{m}{{m}_{j}} )}{\sqrt{{\sum }_{j = 1}^{k} {( {f}_{j} \times log ( \frac{m}{{m}_{j}} ) )}^{2}}} \qquad ( 1 )$$

The associating unit 46 associates morphemes included in an extracted subgraph satisfying a predetermined fifth condition with morphemes included in plural sentences. The association is performed in a case where the correspondence between the morphemes included in the subgraph and the morphemes included in the plural sentences satisfies a predetermined condition (for example, the following fifth condition). A method according to the related art is applied as a method for calculating the correspondence, for example, the method described in Japanese Unexamined Patent Application Publication No. 2008-225582 is used.

The associating unit 46 totals the number of sentences corresponding to a subgraph among plural sentences. In the exemplary embodiment, the associating unit 46 calculates the correspondence between a sentence and a subgraph and associates the sentence with the subgraph on the basis of the calculated correspondence. At this time, the associating unit 46 sets an initial value of the correspondence between the sentence and the subgraph to 0 (zero). In a case where morphemes included in the sentence include two or more morphemes included in the subgraph, the associating unit 46 adds the attribute values of these morphemes to the correspondence, and thereby calculates the correspondence between the sentence and the subgraph. In a case where the correspondence between the sentence and the subgraph satisfies the fifth condition, the associating unit 46 determines that the sentence and the subgraph are associated with each other.

In the exemplary embodiment, the fifth condition is the following (1). In the exemplary embodiment, the attribute value of a morpheme included in a subgraph corresponds to the number of sentences associated with the morpheme. Alternatively, the above-described tf-idf value may be used.

(1) A case where the correspondence between a sentence and a subgraph is equal to or larger than a third threshold that is predetermined as a value representing correlation

A method according to the related art is applied as a method for totaling the number of sentences. For example, the method described in Japanese Unexamined Patent Application Publication No. 2008-225582 is used.

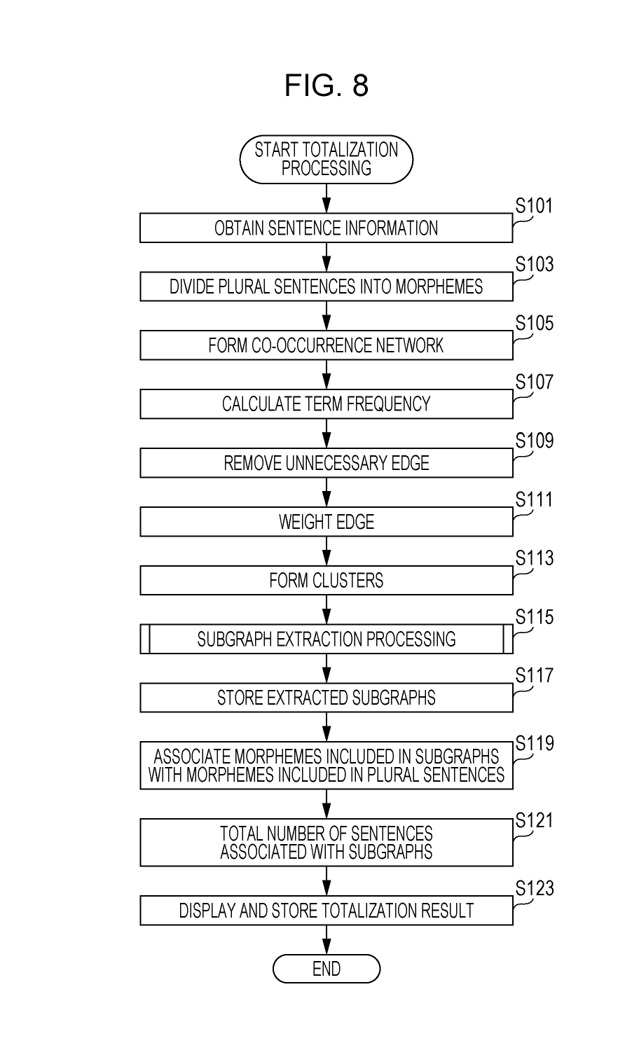

Next, a description will be given of a flow of totalization processing executed by the CPU 14 of the information processing apparatus 10 according to the exemplary embodiment with reference to the flowchart illustrated in FIG. 8.

In the exemplary embodiment, a program of the totalization processing is stored in the nonvolatile memory 20 in advance, but the exemplary embodiment is not limited thereto. For example, the program of the totalization processing may be received from an external apparatus via the communication unit 28 and may be executed. Alternatively, the program of the totalization processing recorded on a recording medium such as a CD-ROM may be read by a CD-ROM drive or the like via the I/O interface 22, and thereby the totalization processing may be executed.

In the exemplary embodiment, the program of the totalization processing is executed when an execution instruction is input by the operation unit 24. The timing at which the program is executed is not limited thereto. For example, the program may be executed every time a certain period elapses.

In step S101, the morphological analysis unit 32 obtains sentence information representing plural sentences. In the exemplary embodiment, the morphological analysis unit 32 obtains the sentence information stored in the nonvolatile memory 20. The method for obtaining the sentence information is not limited thereto, and the sentence information may be obtained from an external server.

In step S103, the morphological analysis unit 32 divides the plural sentences represented by the obtained sentence information into plural morphemes.

In step S105, the morphological analysis unit 32 regards morphemes extracted from among the morphemes obtained through the division as nodes, and connects morphemes having a co-occurrence relation to one another by edges so as to form a co-occurrence network.

In step S107, the frequency calculating unit 36 calculates, for each combination of morphemes, a term frequency at which the two morphemes as a calculation target simultaneously appear in the above-described predetermined region.

In step S109, the unnecessary edge removing unit 38 removes an edge of plural morphemes that are connected to each other in the co-occurrence network and that satisfy the above-described first condition.

In step S111, the edge weighting unit 40 increases the intensity of an edge of plural morphemes that are connected to each other in the co-occurrence network and that satisfy the above-described second condition.

In step S113, the cluster forming unit 42 classifies the individual morphemes included in the co-occurrence network into plural clusters each including plural morphemes related to one another, and thereby forms plural clusters.

In step S115, the subgraph extracting unit 44 performs subgraph extraction processing for extracting, from each of the plural clusters that have been formed, one or more subgraphs each including plural morphemes that satisfy the above-described third condition.

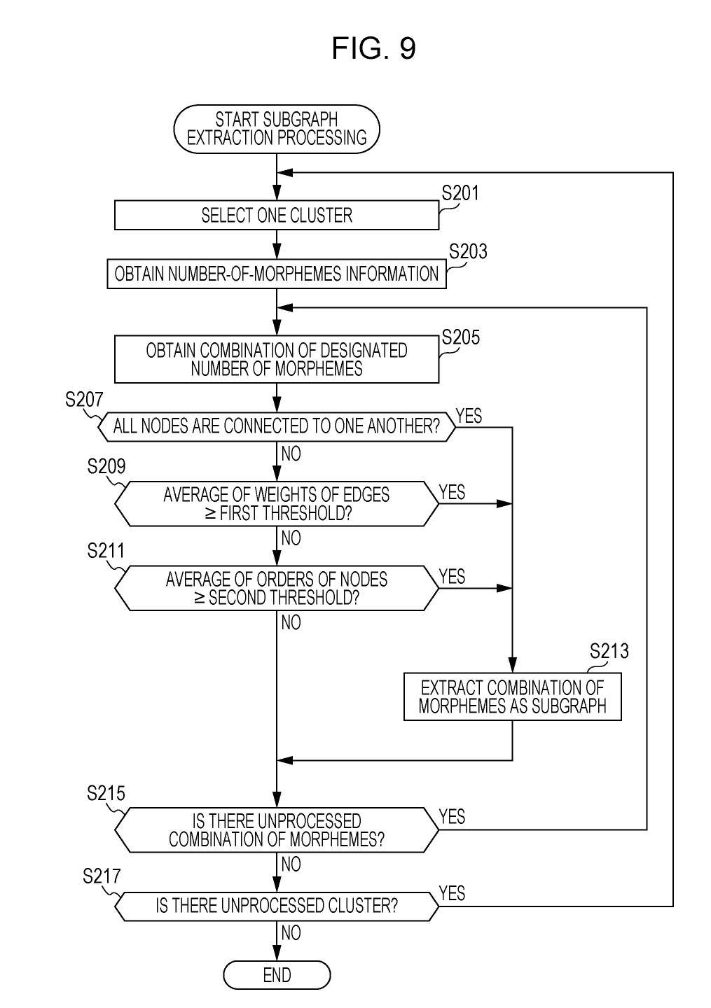

Now, a flow of routine processing in which the subgraph extracting unit 44 performs the subgraph extraction processing will be described with reference to the flowchart illustrated in FIG. 9.

In step S201, the subgraph extracting unit 44 selects one of the plural clusters formed in step S113.

In step S203, the subgraph extracting unit 44 obtains number-of-morphemes information representing the number of morphemes included in a subgraph. In the exemplary embodiment, the number-of-morphemes information is stored in the nonvolatile memory 20 in advance, and the subgraph extracting unit 44 obtains the number-of-morphemes information from the nonvolatile memory 20. However, the method for obtaining the number-of-morphemes information is not limited thereto, and the number-of-morphemes information may be input by using the operation unit 24. The number of morphemes included in a subgraph may be a predetermined threshold or less so that an issue does not become obscure. In the exemplary embodiment, the number of morphemes is five or less.

In step S205, the subgraph extracting unit 44 obtains a combination of morphemes the number of which is a designated number, from the selected cluster.

In step S207, the subgraph extracting unit 44 determines whether or not the morphemes in the obtained combination are morphemes in which all the nodes are connected to one another. If the subgraph extracting unit 44 determines in step S207 that the morphemes are morphemes in which all the nodes are connected to one another, the processing proceeds to step S213. If the subgraph extracting unit 44 determines that the morphemes are not morphemes in which all the nodes are connected to one another, the processing proceeds to step S209.

In step S209, the subgraph extracting unit 44 determines whether or not an average value of weights of edges in the obtained combination of morphemes is equal to or larger than the above-described first threshold. If the subgraph extracting unit 44 determines in step S209 that the average value is equal to or larger than the first threshold, the processing proceeds to step S213. If the subgraph extracting unit 44 determines in step S209 that the average value is smaller than the first threshold, the processing proceeds to step S211.

In step S211, the subgraph extracting unit 44 determines whether or not an average value of orders of nodes in the obtained combination of morphemes is equal to or larger than the above-described second threshold. If the subgraph extracting unit 44 determines in step S211 that the average value is equal to or larger than the second threshold, the processing proceeds to step S213. If the subgraph extracting unit 44 determines in step S211 that the average value is smaller than the second threshold, the processing proceeds to step S215.

In step S213, the subgraph extracting unit 44 extracts the obtained combination of morphemes as a subgraph.

In step S215, the subgraph extracting unit 44 determines whether or not there is an unprocessed combination of morphemes, that is, a combination of morphemes on which the above-described steps S207 to S213 have not been performed. If the subgraph extracting unit 44 determines in step S215 that there is not an unprocessed combination of morphemes, the processing proceeds to step S217. If the subgraph extracting unit 44 determines in step S215 that there is an unprocessed combination of morphemes, the processing returns to step S205, and steps S205 to S213 are performed on the unprocessed combination of morphemes.

In step S217, the subgraph extracting unit 44 determines whether or not there is an unprocessed cluster, that is, a cluster on which steps S201 to S215 have not been performed. If the subgraph extracting unit 44 determines in step S217 that there is an unprocessed cluster, the processing returns to step S201, and steps S201 to S215 are performed on the unprocessed cluster. If the subgraph extracting unit 44 determines in step S217 that there is not an unprocessed cluster, the routine program of the subgraph extraction processing ends.

In step S117 in FIG. 8, the subgraph extracting unit 44 stores the extracted subgraphs in the nonvolatile memory 20.

In step S119, the associating unit 46 associates the morphemes included in the extracted subgraphs with morphemes included in plural sentences.

In step S121, the associating unit 46 totals the number of sentences associated with the subgraphs.

In step S123, the associating unit 46 displays a totalization result on the display unit 26 and stores the totalization result in the nonvolatile memory 20, and execution of the totalization processing program ends.

As described above, the information processing apparatus 10 according to the exemplary embodiment performs clustering on plural morphemes included in a sentence group in two stages, that is, the stage of a cluster representing an outline of an issue and the stage of a subgraph representing a more specific issue. Accordingly, a more specific issue is extracted from the sentence group. Further, the information processing apparatus 10 according to the exemplary embodiment totals the number of sentences corresponding to a subgraph representing a specific issue. Thus, the amount of specific issues is totaled in the sentence group.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a forming unit that forms, from a co-occurrence network representing a correlation among a plurality of morphemes included in a plurality of sentences, a plurality of clusters each including a plurality of morphemes related to one another; and
an extracting unit that extracts, from each of the plurality of clusters formed by the forming unit, one or more subgraphs each including a plurality of morphemes that satisfy a predetermined condition representing a mutual correlation.

2. The information processing apparatus according to claim 1, wherein the forming unit forms, for morphemes that are connected to one another in the co-occurrence network and that have different parts of speech, a plurality of clusters each including a plurality of morphemes related to one another from the co-occurrence network that has a greater intensity of co-occurrence than an intensity of an original co-occurrence.

3. The information processing apparatus according to claim 1, wherein the forming unit forms, from the co-occurence network from which an edge of morphemes that are connected to one another in the co-occurrence network and that have an identical part of speech has been removed, a plurality of clusters each including a plurality of morphemes related to one another.

4. The information processing apparatus according to claim 1, wherein the plurality of morphemes that satisfy the predetermined condition are a plurality of morphemes all of which are connected to one another in the co-occurrence network.

5. The information processing apparatus according to claim 1, wherein the plurality of morphemes that satisfy the predetermined condition are a plurality of morphemes in which an average value or a minimum value of weights of edges between the plurality of morphemes is equal to or larger than a predetermined first threshold.

6. The information processing apparatus according to claim 1, wherein the plurality of morphemes that satisfy the predetermined condition are a plurality of morphemes in which an average value or a minimum value of orders of nodes of the plurality of morphemes is equal to or larger than a predetermined second threshold.

7. The information processing apparatus according to claim 1, further comprising:
a designating unit that designates the number of morphemes included in each of the subgraphs extracted by the extracting unit,
wherein the extracting unit extracts a subgraph including morphemes the number of which is designated by the designating unit.

8. The information processing apparatus according to claim 1, further comprising:
a memory that stores information on a hierarchical structure in which the clusters are in an upper layer and the subgraphs extracted from the clusters are in a layer lower than the clusters.

9. The information processing apparatus according to claim 8, wherein the memory stores the information on the hierarchical structure by using, as a cluster name, a morpheme whose index value indicating a degree of importance of the morpheme is maximum among the morphemes included in the clusters.

10. The information processing apparatus according to claim 1, further comprising:
an associating unit that associates morphemes included in the subgraphs extracted by the extracting unit with morphemes included in the plurality of sentences.

11. The information processing apparatus according to claim 10, further comprising:
a totaling unit that totals, in accordance with attribute values of the morphemes included in the subgraphs extracted by the extracting unit, the number of sentences belonging to each of the subgraphs.

12. An information processing method comprising:
forming, from a co-occurrence network representing a correlation among a plurality of morphemes included in a plurality of sentences, a plurality of clusters each including a plurality of morphemes related to one another; and
extracting, from each of the plurality of clusters that have been formed, one or more subgraphs each including a plurality of morphemes that satisfy a predetermined condition representing a mutual correlation.

13. A non-transitory computer readable medium storing a program causing a computer to execute a process, the process comprising:
forming, from a co-occurrence network representing a correlation among a plurality of morphemes included in a plurality of sentences, a plurality of clusters each including a plurality of morphemes related to one another; and
extracting, from each of the plurality of clusters that have been formed, one or more subgraphs each including a plurality of morphemes that satisfy a predetermined condition representing a mutual correlation.
